(19) United States
(12) Patent Application Publication
(10) Pub. No.: US 2016/0053917 A1
(43) Pub. Date: Feb. 25, 2016

(54) CONDUIT HANGER

(71) Applicant: Ssorrich Pty Ltd, Sapphire Beach (AU)

(72) Inventors: Darcien Kean, Sapphire Beach (AU); Ben Burns, Sapphire Beach (AU)

(21) Appl. No.: 14/466,052

(22) Filed: Aug. 22, 2014

(51) Int. Cl. F16L 3/10; F16L 3/223

(52) U.S. Cl. CPC F16L 3/1075; F16L 3/2235

(57) ABSTRACT

A conduit hanger includes a base. At least one carrier extends from the base. The carrier(s) define a retaining formation in which a respective conduit can be received. The base and the carrier(s) are formed from at least one flat sheet of material. At least one obstruction member is mounted on one of the base and the, or each respective, carrier and is displaceable between an inoperative position in which the conduit can be removed from the respective carrier and an operative position in which the conduit is retained in the respective carrier with the obstruction member.

### FIELD

Various exemplary embodiments described herein relate to a conduit hanger. The embodiments relate also to a system and to a method for supporting conduits.

### SUMMARY

Various exemplary embodiments described herein relate to a conduit hanger which comprises

a base;

at least one carrier extending from the base, the, or each, carrier defining a retaining formation in which a respective conduit can be received, the base and the carrier(s) being formed from at least one flat sheet of material; and

at least one obstruction member mounted on one of the base and the, or each respective, carrier and displaceable between an inoperative position in which the conduit can be removed from the respective carrier and an operative position in which the conduit is retained in the respective carrier with the obstruction member.

A number of carriers may extend from the base. For example, three carriers may extend from the base. Thus, a number of obstruction members may be arranged on the base to correspond with respective carriers.

The base and the carriers may be formed from a sheet of metal, such as steel or aluminium. The sheet may be stamped, molded, or cut, for example, water cut, to define the base and the carriers.

The base may be elongate with the carriers extending from one side of the base. Each carrier may define an arcuate inner surface to accommodate the conduit. The obstruction members may be in the form of locking members or bars that are pivotally connected or fastened to the base to be pivotal between the operative and inoperative positions. It will be appreciated that the locking members or bars can, instead, be pivotally connected to respective carriers.

In the operative position, the bars extend from the base to a free end of the associated carrier. A free end of the bar or locking member and the free end of the carrier may have corresponding openings that can be brought into register with each other so allowing a fastening device to be received through the openings to fasten the locking members to the carriers. Thus, the bar can be locked or secured to the free end of the associated carrier. Alternatively, the bars can extend from the free end of the associated carrier to the base. In that case, one end of the bar can be pivotally connected to the carrier while the free end can be locked or secured to the base.

The conduit hanger can include a supplementary carrier arranged on an end of the base, or anywhere else where such a supplementary carrier would be convenient or useful.

The conduit hanger is useful for underground mining where it is necessary to retain conduits in a position away from a working area in a tunnel, for example. Thus, the conduit hanger can be mounted on a hanging wall, or similar, in an underground mine. To that end, the conduit hanger may include a mounting arrangement to allow the conduit hanger to be mounted on such a structure.

The mounting arrangement may include one or more longitudinal slots defined in the base. A pin, shank or the like of a fastening arrangement may be received in the, or each, slot. Thus, the hanger can be mounted to a support structure in an adjustable manner both with respect to the support structure and one or more further conduit hangers. Connectors may be engaged with the base via the pin, shank or the like, such as that found in a D-shackle, arranged on ends of the connectors and received through the slots. Thus, the connectors can be both pivotally and linearly displaceable with respect to the base. Instead, the connectors can simply be connected to chains or other flexible connectors that are fastened to the support structure allowing the pivotal and linear movement or displacement.

As is known, roof anchors or roof bolts are generally used to maintain the integrity of a hanging wall or the like in an underground mine. Thus, the mounting arrangement can include suitable mounting members arranged on the roof bolts to permit the connectors to be mounted on the roof bolts. For example, the mounting members can be in the form of eye bolts, D-shackles or the like arranged on the roof bolts so that the connectors can be hooked onto the roof bolts. Instead, where the connectors are flexible, the connectors can simply be threaded around existing reinforcing mesh, or a similar structure, to support the conduit hanger.

Various exemplary embodiments of a conduit hanging system comprise

a plurality of conduit hangers, each conduit hanger comprising

a base;

at least one carrier extending from the base, the, or each, carrier defining a retaining formation in which a respective conduit can be received, the base and the carrier(s) being formed from at least one flat sheet of material; and

at least one obstruction member mounted on one of the base and the, or each respective, associated carrier and displaceable between an inoperative position in which the conduit can be removed from the respective carrier and an operative position in which the conduit is retained in the respective carrier with the obstruction member; and

wherein the conduit hangers are mounted on a support structure to support the conduit(s) along its/their length(s).

Various exemplary embodiments of a method of supporting conduits comprises the steps of:

mounting a plurality of conduit hangers on a support structure, each conduit hanger comprising

a base;

at least one carrier extending from the base, the, or each, carrier defining a retaining formation in which a respective conduit can be received, the base and the carrier(s) being formed from at least one flat sheet of material; and

at least one obstruction member mounted on one of the base and the, or each respective, associated carrier and displaceable between an inoperative position in which the conduit can be removed from the respective carrier and an operative position in which the conduit is retained in the respective carrier with the obstruction member; and

securing a conduit to at least two consecutive carriers of the hangers.

Various exemplary embodiments described herein relate to a system for supporting conduits, the system comprising a plurality of the conduit hangers as described above mounted in a generally aligned orientation so that at least one conduit can span at least two of the conduit hangers when received in the carriers in the manner described above.

Various exemplary embodiments described herein relate to a method of supporting conduits on a structure, the method comprising the steps of:

mounting a plurality of the conduit hangers as described above; and

securing at least one conduit to at least two consecutive carriers of respective hangers in the manner described above.

### DESCRIPTION OF THE DRAWINGS

FIG. 1 shows a side view of an exemplary embodiment of a conduit hanger.

FIG. 2 shows a three-dimensional view of part of the conduit hanger, illustrating a manner in which a conduit is secured to the conduit hanger.

FIG. 3 shows a three-dimensional view of the conduit hanger without obstruction or locking members.

FIG. 4 shows a side view of two conduit hangers arranged for packaging.

FIG. 5 shows a three-dimensional view of two of the conduit hangers, in use.

FIG. 6 shows a three-dimensional view of another application of a number of the conduit hangers.

FIG. 7 shows a three-dimensional view of part of the conduit hanger, illustrating another manner in which the conduit is secured to the conduit hanger.

FIG. 8 shows a front view of a further exemplary embodiment of a conduit hanger.

FIG. 9 shows a side view of the conduit hanger of FIG. 8.

FIG. 10 shows a side view of two exemplary embodiments of a conduit hanger arranged for packaging.

FIG. 11 shows a side view of a further exemplary embodiment of a conduit hanger.

### DESCRIPTION OF THE EMBODIMENTS

In the drawings, reference numeral 10 generally indicates an exemplary embodiment of a conduit hanger.

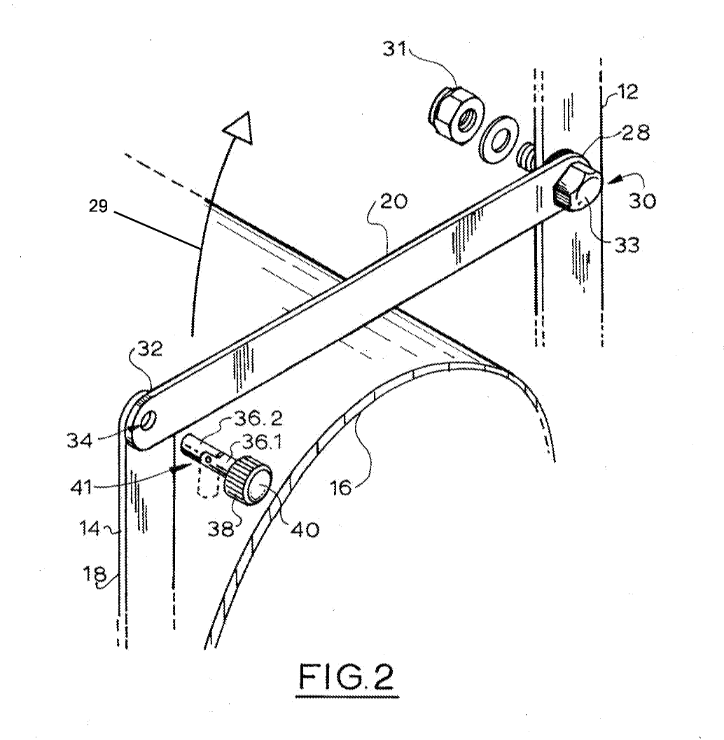

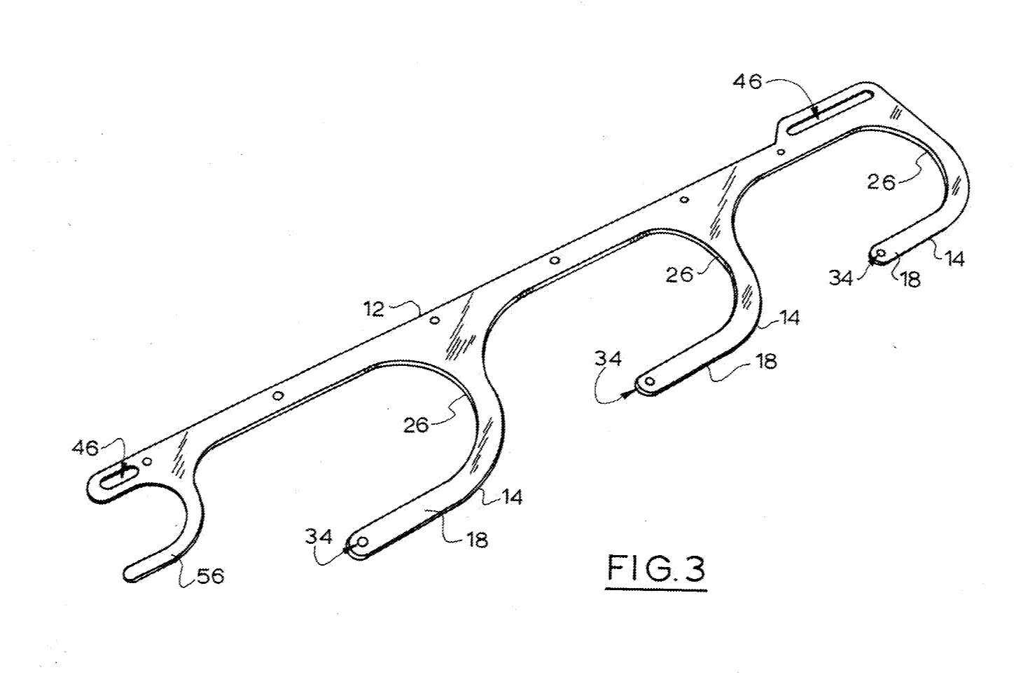

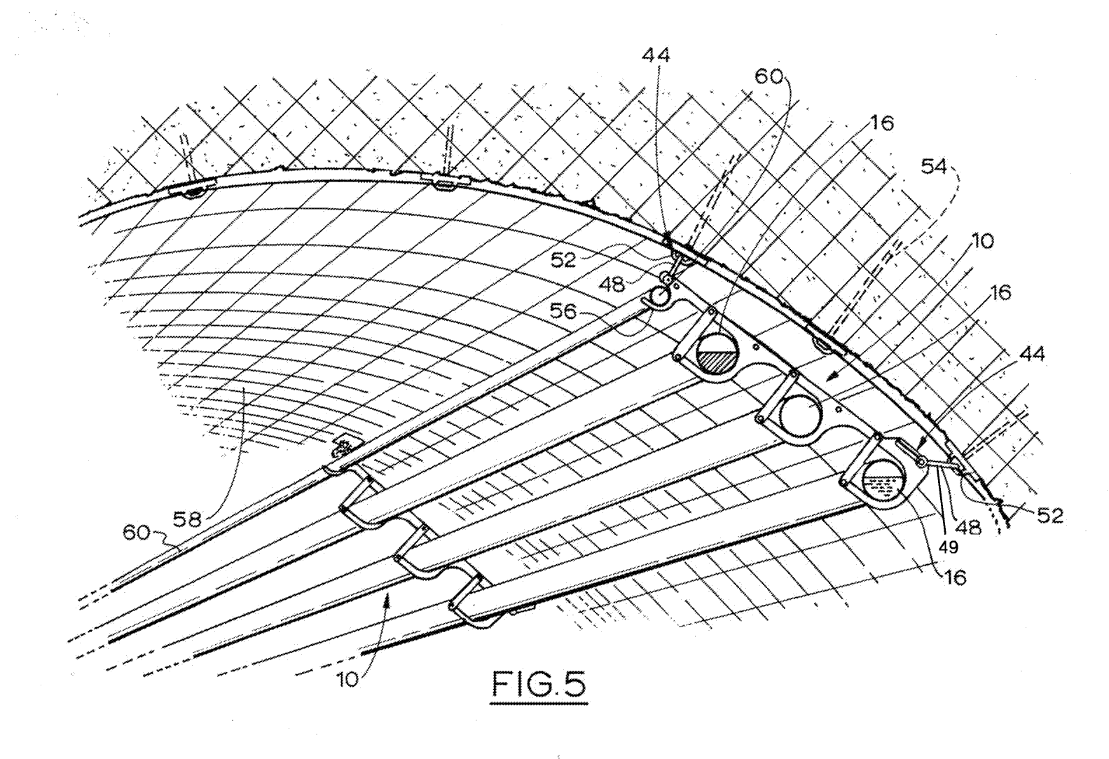

The conduit hanger 10 includes a base 12. Three carriers 14 extend from the base 12 and define retaining formations 18 in which conduits 16 (FIGS. 2 and 5) are received. Obstruction members in the form of locking members 20 are arranged on the base 12 and are displaceable between an inoperative position indicated at 22 in which the conduits 16 can be removed from the carrier 14 and an operative position indicated, for example, at 24, in which the conduits 16 are retained in the carrier 14 by the locking member 20.

The base 12 and the carriers 14 are of a unitary one-piece construction. In this example, the base 12 and the carriers 14 are formed from a sheet of metal, such as steel or aluminium. Thus, the sheet can be stamped to form the base 12 and the carriers 14. It is to be appreciated that the geometry of such a structure provides optimal strength and integrity with the use of a minimal amount of material. For example, pressure exerted by conduits in the carriers 14 generates force vectors that extend into the sheet of metal. Such a structure is inhibited from bending as a result of such force vectors. In order to enhance the structural integrity of the hanger 10, the sheet can be water cut instead of stamped so that heat and subsequent weakening of the hanger 10 is avoided.

The metal can, in one example, be of mild galvanised steel to prevent rusting in corrosive environments such as in underground mines. The sheet of galvanised steel can have a thickness of between about 4 mm and 8 mm, for example about 6 mm.

The base 12 is elongate and the carriers 14 extend from one side of the base 12. Each carrier 14 defines an arcuate inner surface 26 that is shaped to accommodate the conduit 16. The inner surface 26 can have a diameter of between about 100 mm and 120 mm, for example about 110 mm. However, it will be appreciated that this can be varied depending on the required application, namely, the diameter of the conduits. For proper fitting, the diameter of the arcuate inner surface 26 can be about 10% or 10 mm greater than the diameter of the conduits 16.

Thus, the inner surface 26 can have a generally U-shaped profile. The obstruction or locking members 20 are in the form of bars that are pivotally connected, at one end 28, to the base 12 to be pivotal between the operative and inoperative positions as indicated by arrows 29. In particular, each bar can be connected to the base 12 with a suitable pivot pin assembly 30. The pivot pin assembly 30 can be in the form of a nut and bolt assembly having a nut 31 and a bolt 33, as shown in FIG. 2. The bars 20 can also be formed from a sheet of metal such as aluminium or steel. Thus, when the bars 20 and base 12 are disassembled, the respective components can be packaged in a flat format, so resulting in a space saving. This can be significant for large scale deployment of the hangers 10, for example, in a mine tunnel or the like.

Each carrier 14 is dimensioned so that when the conduit 16 is received in the carrier 14, a free end 32 of the carrier 14 extends past the conduit 16 such that the carrier 14 and an associated part of the base 12 define sides of a region greater in area than a cross section of the conduit.

The bars 20 are elongate and generally straight. Furthermore, the bars 20 are pivotally connected to the base 12 at a position with respect to the free end 32 of the associated carrier 14. Thus, when the conduit 16 is received in the carrier 14, the associated bar can extend over the conduit 16 and engage with the free end 32 when in its operative condition. It is envisaged that the bars 20 can be pivotally connected to the free end 32 of the carrier 14 so that, in use, the bar 20 can extend over the conduit and engage with the base 12.

The bar 20 and the free end 32 of the carrier 14 define complementary openings 34 that can be brought into alignment with each other when the bar 20 is pivoted into its operative position. A shank 36 of a locking pin 38 can be received through the openings 34 to lock the bar 20 in position with respect to the carrier 14. For example, the shank 36 can include two parts 36.1 and 36.2 that are hinged together at 41. The part 36.1 extends from a head 40 of the pin 38 and is of a suitable length to pass through the openings 34. The part 36.2 can then be hinged with respect to the part 36.1 to secure the pin 38 in position. Thus, the pin 38 is inhibited from vibrating loose, or otherwise detaching itself from the carrier 14 and bar 20.

It will be appreciated that the hanger 10 can be used in a number of different environments. One such an environment is in an underground mine. In such an environment, the hanger 10 can be mounted on a tunnel wall or roof 42, as shown in FIG. 5.

To that end, the conduit hanger 10 includes a mounting arrangement 44 that is configured for such mounting.

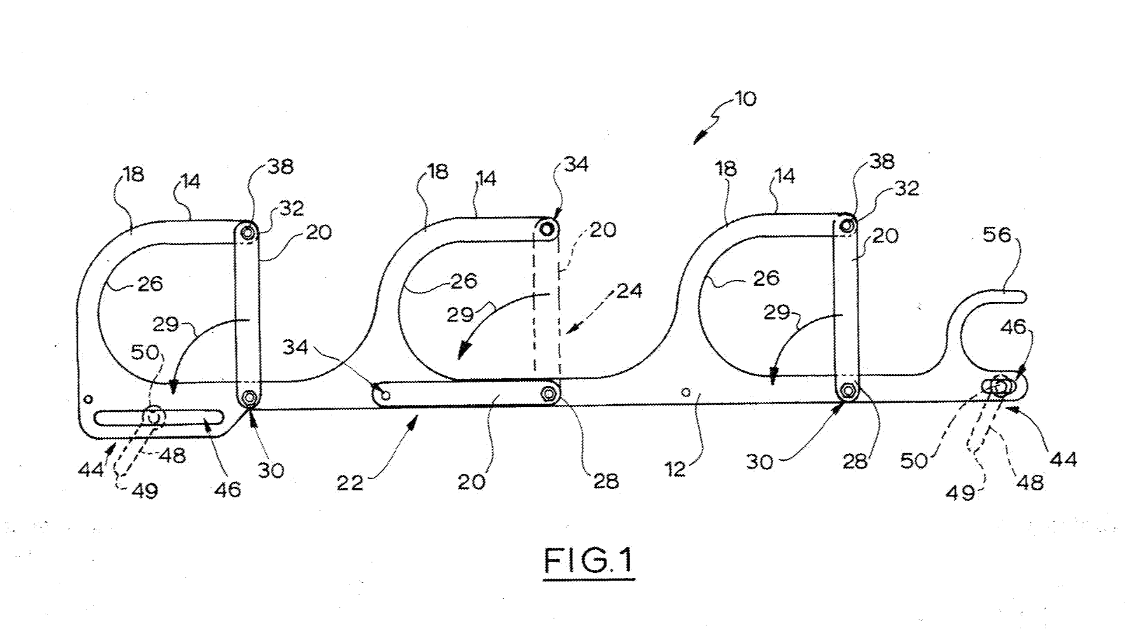

The mounting arrangement 44 includes two longitudinally extending slots 46 defined in the base 12. Connectors 48 are engaged with the base 12 in a pivotal manner. Thus, the connectors 48 can be in the form of D-shackles. Pins or bolts 50 (FIG. 1) of the shackles 48 can extend through respective slots 46 with crowns 49 of the shackles 48 being accessible for connection of the hanger 10 to a support structure.

Thus, the connectors 48 can be both pivotally and linearly displaceable with respect to the base 12. The connectors 48 can be in different forms. For example, when the connectors 48 are in the form of D-shackles, the crowns 49 can be connected to a loop of a chain. Alternatively, the crowns 49 can be connected directly to a support structure.

The mounting arrangement 44 also includes mounting members in the form of connectors 52, such as looped connectors or the like that are arranged on a support structure. For example, the connectors 52 can be in the form of connectors pre-arranged on the support structure. The connectors 52 can be connectors pre-arranged on the tunnel or hanging wall 52. The D-shackles 48 can be connected directly to such connectors 52 by engagement with the crowns 49, as shown in FIG. 5. Instead, the D-shackles 48 can be connected to such connectors with the chains or the rigid connectors.

The connectors 52 might not be specific, built-for-purpose connectors. They could simply be existing formations or members that form part of the support structure. In one example, the connectors 52 can be arranged on, or fastened to, heads of roof bolts 54.

In one example, the chains mentioned above or other flexible connectors, such as wire rope, can simply be looped around reinforcing mesh in the tunnel or hanging wall within a mine or some such similar environment. Instead, other forms of connectors can be used to connect the hanger 10 to the wall or roof or the reinforcing mesh. For example, a rope, wire or some other flexible connector can be threaded through at least one of the slots 46 and tied to an appropriate structure in or on the wall or roof.

In any of the examples, the connectors 48 can pivot with respect to the connectors 52. As a result, the connectors 48 are both pivotally and linearly displaceable with respect to the base 12. That allows for adjustment to suit different underground situations. In particular, it allows for adjustment of a number of the hangers 10 to accommodate the conduits 16.

Instead of being fastened to the roof bolts 54, the elongate connectors 48 can have suitable clips or other fasteners to allow them to be clipped or fastened to a reinforcing mesh 58 which is arranged on the tunnel wall 42.

As can be seen in FIG. 5, the hanger 10 is capable of supporting three service conduits 16. However, a supplementary carrier 56 can also be arranged on the base 12 for supporting a further conduit or electrical line, or similar, indicated at 60. The supplementary carrier may have an arcuate profile with a diameter of between about 60 mm and 70 mm, for example 66 mm.

The inventor(s) envisages that the hanger 10 can be mounted in a wide variety of orientations. It follows that a system of the hangers 10 can be positioned so that the conduits 16, 60 are positioned in a location in which they are safely spaced from operations that may be occurring in the tunnel, or other location.

This is particularly the case since the carriers 14 all extend from one side of the base 12. As result, the conduits 16, 60 can be drawn up towards the roof or tunnel wall in an aligned configuration with the base 12 adjacent the roof or tunnel wall.

When used as a system, as shown in FIG. 5, the hangers 10 are suited for supporting the conduits 16, 60 in a spaced, orderly fashion. Further, the locking members 20 allow the conduits 16, 60 to be removed or replaced in a convenient manner. This can enhance the speed and efficiency of maintenance. In large operations, such as mining operations, such improvements can lead to a significant savings in man-hours and thus costs. Furthermore, the manner in which the conduits 16, 60 are secured in the hangers 10 provide a system in which the danger associated with a conduit breaking loose and falling down is alleviated.

In use, the hangers 10 are mounted on the wall 42, in the manner described above, in a generally aligned orientation along a path for the conduits 16, 60. The bars 20 are then pivoted into their inoperative positions. The conduits 16, 60 are positioned in the carriers 14, as described above. The bars 20 are then pivoted into the operative positions and secured with the locking pin 38.

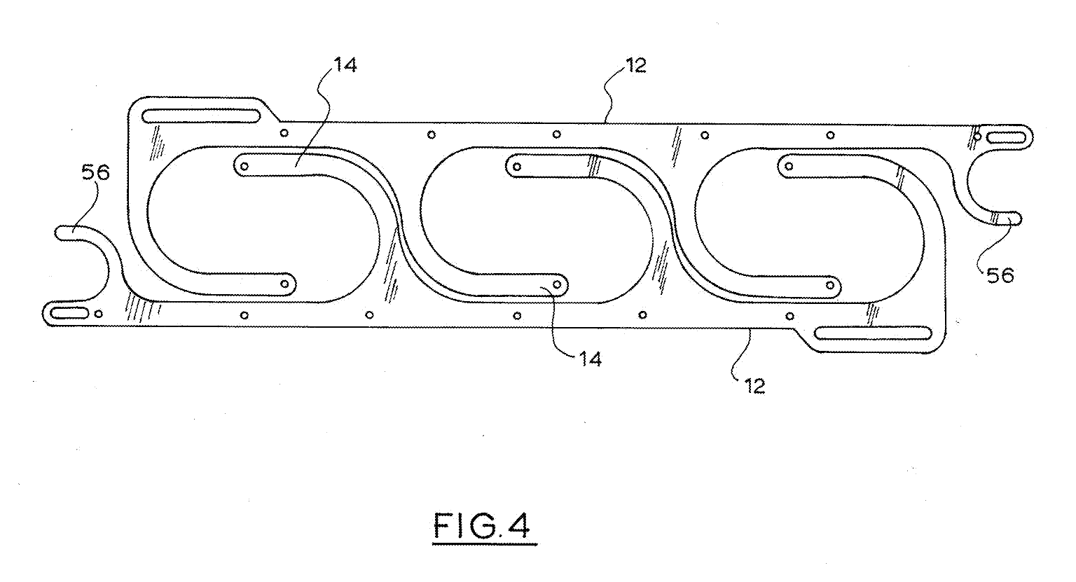

The fact that the hanger 10 and carriers 14 can be made from a single sheet of metal or suitable material, can facilitate an increased efficiency of manufacture. Not only that, but packaging of the hangers 10 is improved. For example, as shown in FIG. 4, a pair of the hangers 10 can be packaged in a nesting manner. This can ensure that packaging and storage space required is kept to a minimum. Once unpacked, the locking members 20 can simply be attached, as shown in FIG. 2, with the pivot pin assembly 30 using conventional tools.

As mentioned above, it may be necessary to utilise a large number of the hangers 10 over a long distance. This mode of packaging and storage can thus be useful for deployment of the hangers 10. For example, the event that the hangers 10 were not in a flat configuration, it would be difficult to achieve effective packaging configurations that would suit multiple deployment.

At present, chain and D-shackle systems are used to hang conduits. This can be time-consuming. For example, the inventors have found that in some instances it can take up to 10 minutes to hang three sections of piping on such hangers. In contrast, tests have found that the hanger 10 can be used to hang similar sections of piping in 2 to 5 minutes. Usefully, chain and D-shackles that are presently available in mines and similar locations can be used with the hanger 10, as described above.

The locking members 20 can be unlocked and locked any number of times. That, coupled with the slots 46, allows the hanger 10 to mounted only once for repeated use. Furthermore, the slots 46 and the elongate connectors 48 allow the hanger 10 to be hung at a range of angles between about vertical and parallel to a support structure. It follows that the conduits can be arranged to avoid contact with vehicles that could otherwise rub on the conduits or strike existing hanger arrangements.

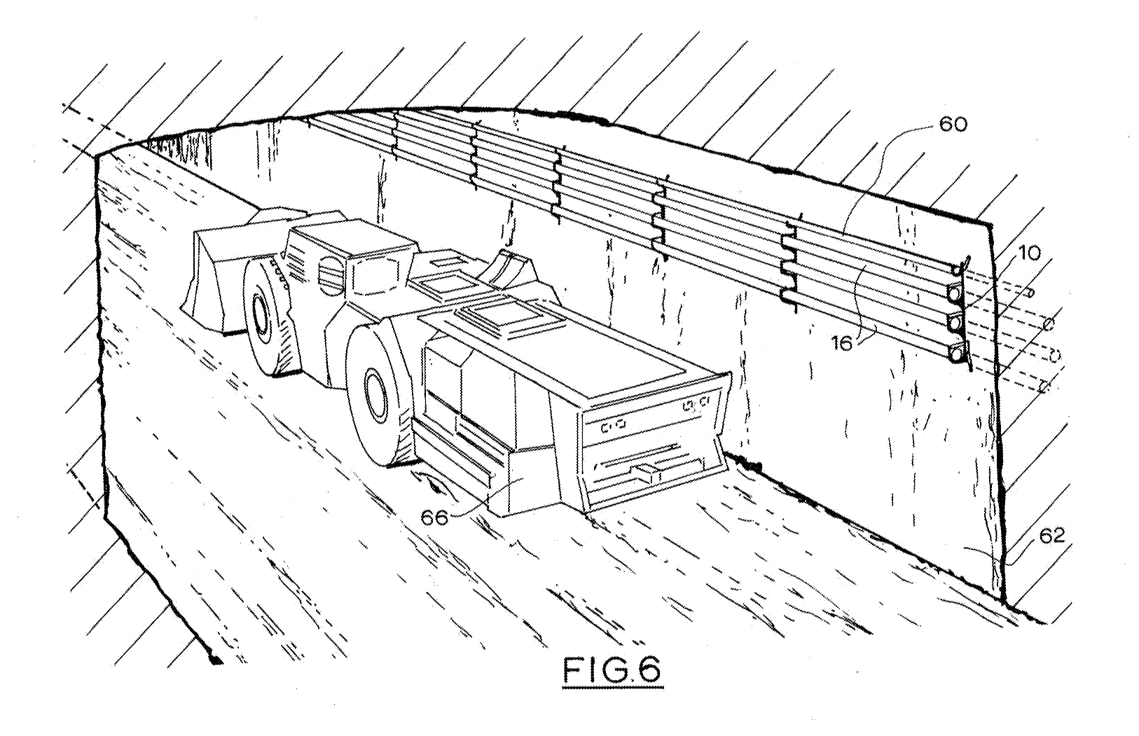

In FIG. 6, the hanger 10 is mounted in a vertical orientation on a side wall 62 of a tunnel 64. As can be seen, a number of the hangers 10 can be used to retain the conduits 16, 60 against the side wall 62 where damage from vehicles, such as the vehicle 66, can be avoided. In this case, for example, the D-shackles 48 can be connected directly to the side wall 62.

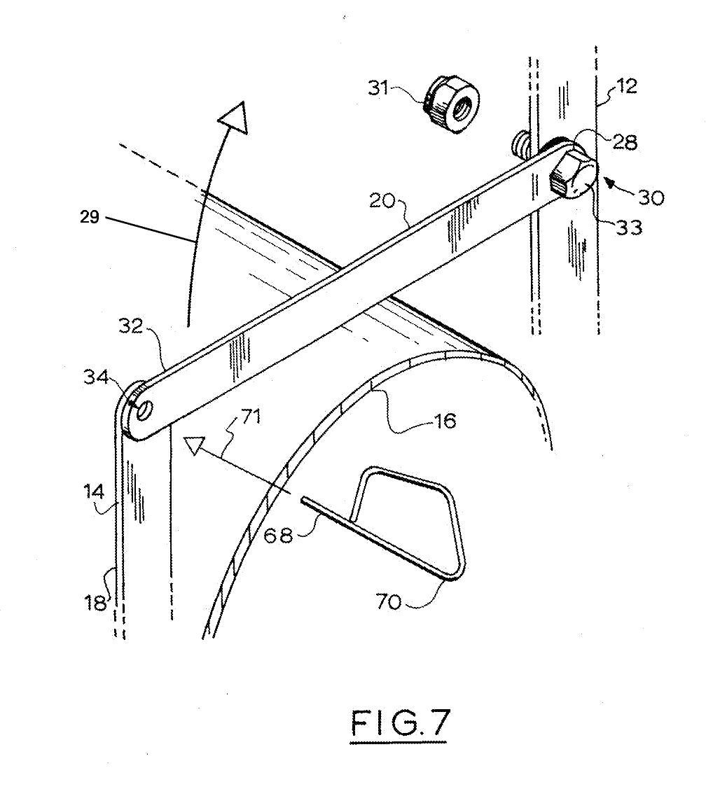

In FIG. 7, there is shown an alternative manner of fastening the bars 20 to the carriers 14. Once the openings 34 are in alignment, a prong 68 of a clip 70 is urged, in the direction of an arrow 71, into the openings 34, causing the clip 70 to engage the carrier 14 and the bar 20.

The clip 70 can be in the form of a safety clip, such as a Minsup (trade mark) clip, or the like. This is particularly convenient since such clips are often found in use in mines and similar environments. This is significant since the ready availability of such clips can reduce the extent of time required to hang or position the conduits with the hanger 10. In a large-scale operation, any reduction in time can result in a significant cost saving.

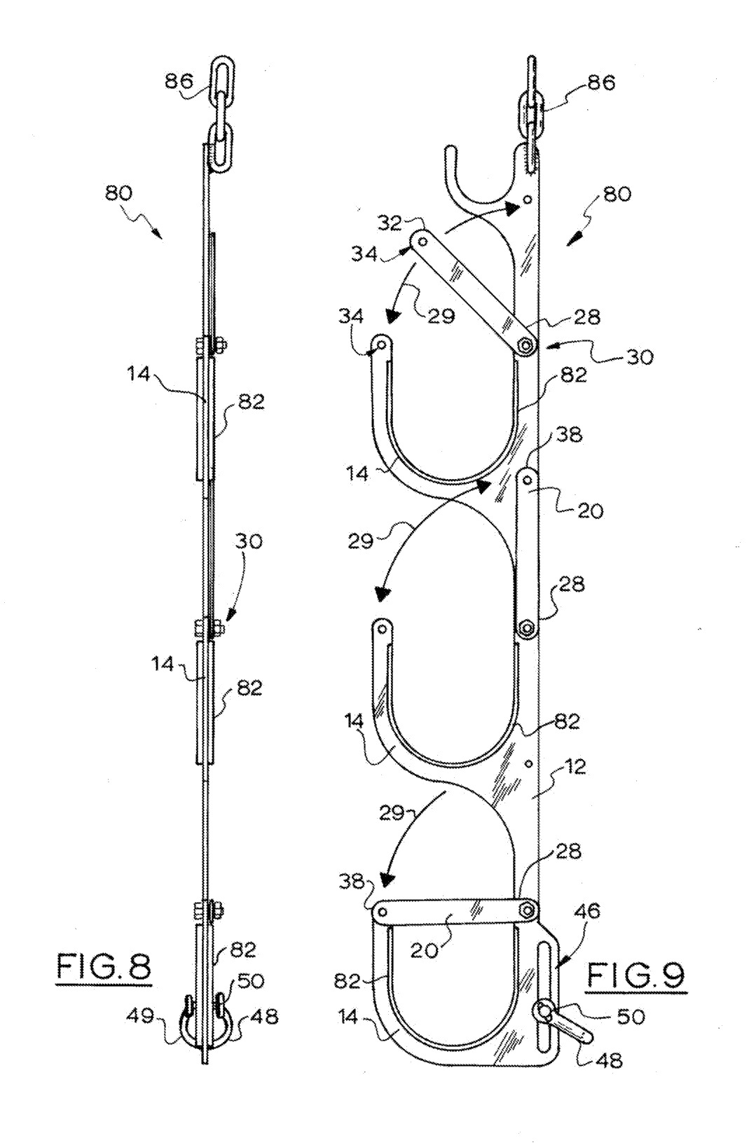

In FIGS. 8 and 9, reference numeral 80 generally indicates a further exemplary embodiment of a conduit hanger. With reference to the preceding drawings, like reference numerals refer to like parts, unless otherwise specified. The use of common reference numerals is for convenience only and is not intended to limit the scope of the appended claims. Furthermore, components described with reference to the preceding drawings are interchangeable with components of the conduit hanger 80. The characteristics and uses attributed to the hanger 10 are also attributable to the hanger 80, unless otherwise specified.

In some cases, the conduits may be susceptible to damage as a result of their weight and/or the material from which the conduits 16 are fabricated. Thus, conduit support members 82 can be arranged on the carriers 14 to support the conduits 16. The support members 82 can be strips of metal sheeting that are welded or otherwise fastened to the carriers to provide a bearing surface for the conduits 16. The strips need not be of metal and can be of any other suitable material. The strips 82 can be one piece structures or can be in two parts, one part on each side of the associated carrier 14.

The strips are of a suitable width to disperse the pressure exerted on the conduits 16 by the carriers with the conduits 16 resting on the support members 82.

In this embodiment, just one lower slot 84 can be provided with the pin or bolt 50 of the D-shackle 48 received through the slot 84.

A chain 86 can be fastened or welded to an upper end of the base 12.

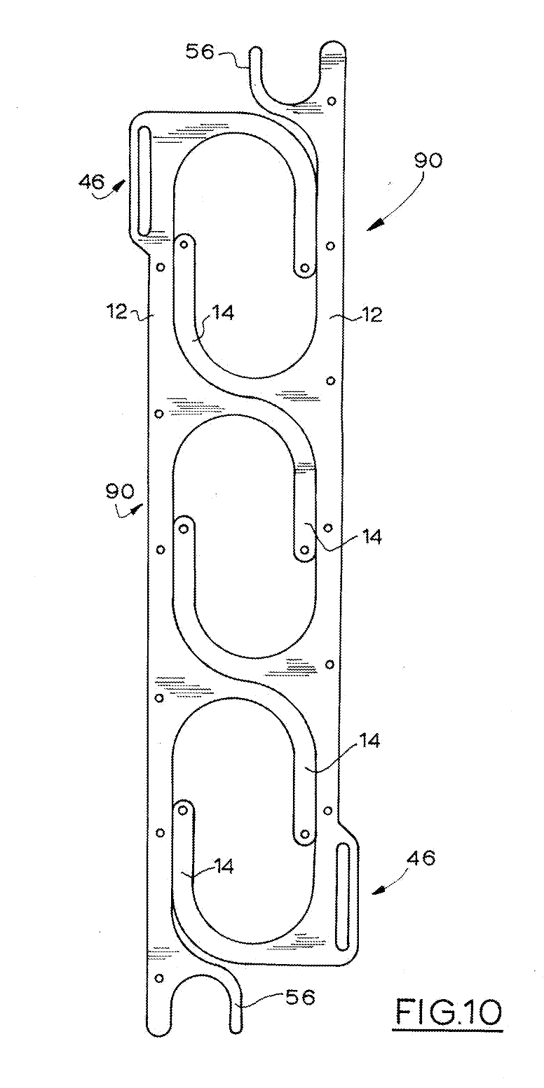

In FIG. 10, reference numeral 90 generally indicates a further exemplary embodiment of a conduit hanger. With reference to the preceding drawings, like reference numerals refer to like parts, unless otherwise specified. The use of common reference numerals is for convenience only and is not intended to limit the scope of the appended claims. Furthermore, components described with reference to the preceding drawings are interchangeable with components of the conduit hanger 90. The characteristics and uses attributed to the hanger 10, 80 are also attributable to the hanger 90, unless otherwise specified.

The conduit hanger 90 lacks the support members 82.

Also, FIG. 10 illustrates how two of the conduit hangers 90, without the bars 20, can be packed or arranged relative to each other in a space-saving manner.

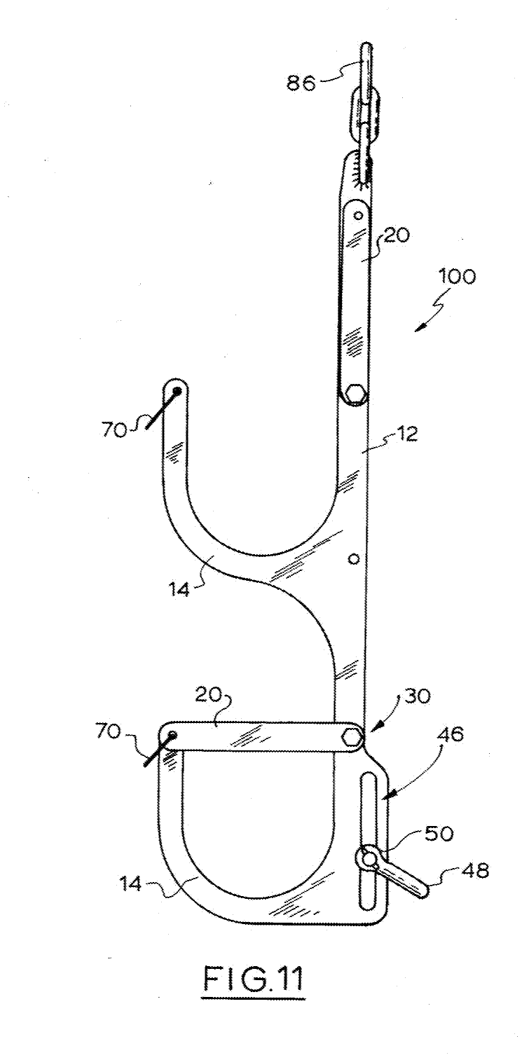

In FIG. 11, reference numeral 100 generally indicates a further exemplary embodiment of a conduit hanger. With reference to the preceding drawings, like reference numerals refer to like parts, unless otherwise specified. The use of common reference numerals is for convenience only and is not intended to limit the scope of the appended claims. Furthermore, components described with reference to the preceding drawings are interchangeable with components of the conduit hanger 10, 90. The characteristics and uses attributed to the hanger 10, 80, 90 are also attributable to the hanger 100, unless otherwise specified.

The hanger 100 has two of the carriers 14. This illustrates that any number of carriers 14 can be arranged on the base 12, depending on the application.

The inventors have found that current hooks and hangers tend to hang too low. Also, they cannot be adjusted without the aid of pre-chaining each conduit to the hook or hanger and then shackling the hooks in position. Such an operation usually requires at least two operators and can be dangerous since the hook cannot be moved by hand. It is usual practice to move the hook by pushing into place with a work basket once the conduit is positioned in the hook with a chain. Without the chain, the conduit can pop out of the hook, which could result in injury. In contrast, the locking members 20 serve to inhibit uncontrolled movement, thereby enhancing operational safety.

In one example, the carriers 14 are configured for supporting conduits in the form of polyurethane pipes. That pipe can have a diameter of about 110 mm. Thus, the arcuate inner surface 26 of each carrier 14 can have a diameter of about 120 mm. The relationship between the pipe diameter and the inner surface can be used to determine appropriate inner surface diameters for different pipes. Thus, the use of these dimensions is not intended to be limiting. Furthermore, the pipe need not be fabricated of polyurethane. The pipe could be of a different plastics material such as polypropylene or HDPE. Also, the pipe could be of metal, such as stainless steel, galvanised steel or aluminium.

The diameter of the inner surface 26 allows enough room to easily slide the conduits 16 into the carriers 14.

The conduit hangers described above provide a means for separating the conduits 16 in an orderly fashion over significant distances. For example, in a mine, a tunnel can extend a number of kilometres. By utilising a series of the hangers, the conduits 16 can be kept clearly separate. This allows isolation of a conduit a significant distance from an operational zone with identification of the isolated conduit being made simply with reference to the particular carrier in which that conduit is positioned. This can enhance the safety of a maintenance or similar operation. For example, it may be necessary to isolate a line or conduit for the purposes of bleeding to ensure depressurisation. It follows that the conduit hangers can be used to identify the conduits a distance away from a connection point of those conduits.

Given the ease of conduit mounting, it is only necessary to have one person in a lift basket or similar in order to carry out a pipe installation operation.

The existence of the slot(s) in the base 12 allows the hangers to be adjusted relative to each other to accommodate the series of conduits. Such adjustment could include aligning respective carriers 14 with each other along a conduit path. The slots also allow the hangers to be hung or mounted on the roof or tunnel wall at any angle between vertical and horizontal.

The conduit hangers described above provide a means of mounting or installing conduits in a neat and orderly fashion. This can provide a sense of good organisation which is desirable in any operation.

A method of installing the hangers described about and mounting conduits on or in the hangers can include the following steps:

1. Acquire a sufficient number of hangers. For example, one hanger for every three meters may be sufficient. The positions of the hangers could correspond with the positions of rock plates, allowing connection of the hangers to respective rock plates, as described above.

2. Fasten, for example by shackling, an upper end of each hanger to the support structure. Depending on the location, this will cause the hangers to hang down, facilitating location of the conduits 16 in the carriers 14.

3. Pivot the locking members or bars 20 into their inoperative positions.

4. Position the conduits 16 in the carriers 14.

5. Pivot the bars 20 into their operative positions and lock them into place as described above.

6. Position the hangers, for example by pushing the hangers into a position in which lower ends of the hangers can be fastened to the support structure either directly or with a chain or other elongate connector such that both ends of the base are fastened or secured to the support structure.

It will be appreciated that the method described above can be carried out by a single person provided the correct sequence of operations is carried out.

Throughout the specification, including the claims, where the context permits, the term “comprising” and variants thereof such as “comprise” or “comprises” are to be interpreted as including the stated integer or integers without necessarily excluding any other integers.

It is to be understood that the terminology employed above is for the purpose of description and should not be regarded as limiting. The described embodiments are intended to be illustrative of the invention, without limiting the scope thereof. The invention is capable of being practised with various modifications and additions as will readily occur to those skilled in the art.

The use of any and all examples, or exemplary language (e.g., “such as”) provided herein, is intended merely to better illuminate one or more embodiments and does not pose a limitation on the scope of any claimed subject matter unless otherwise stated. No language in the specification should be construed as indicating any non-claimed subject matter as essential to the practice of the claimed subject matter.

The use of words that indicate orientation or direction of travel is not to be considered limiting. Thus, words such as “front”, “back”, “rear”, “side”, “up”, down”, “upper”, “lower”, “top”, “bottom”, “forwards”, “backwards”, “towards”, “distal”, “proximal”, “in”, “out” and synonyms, antonyms and derivatives thereof have been selected for convenience only, unless the context indicates otherwise. The inventor envisages that various exemplary embodiments of the claimed subject matter can be supplied in any particular orientation and the claimed subject matter is intended to include such orientations.

Recitation of ranges of values herein are merely intended to serve as a shorthand method of referring to each separate value falling within the range and each separate value is incorporated into the specification as if it were individually recited herein. For example, if a range of 1 to 10 is described, that range includes all values there between, such as for example, 1.1, 2.5, 3.335, 5, 6.179, 8.9999, etc., and includes all subrings there between, such as for example, 1 to 3.65, 2.8 to 8.14, 1.93 to 9, etc.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

1. A conduit hanger which comprises
a base;
at least one carrier extending from the base, the, or each, carrier defining a retaining formation in which a respective conduit can be received, the base and the carrier(s) being formed from at least one flat sheet of material; and
at least one obstruction member mounted on one of the base and the, or each respective, carrier and displaceable between an inoperative position in which the conduit can be removed from the respective carrier and an operative position in which the conduit is retained in the respective carrier with the obstruction member.

2. The conduit hanger as claimed in claim 1, in which the base is elongate and a number of the carriers extend from the base and a number of the obstruction members are arranged on the base to correspond with respective carriers.

3. The conduit hanger as claimed in claim 1, in which the base and carriers are formed from at least one flat sheet of metal.

4. The conduit hanger as claimed in claim 2, in which the obstruction members are in the form of locking members that are fastenable to the base in a pivotal manner so that they can pivot between the operative and inoperative positions, with free ends of the locking members and the carriers being configured so that the free ends can be releasably fastened to the carriers.

5. The conduit hanger as claimed in claim 4, in which the free ends of the locking members and the carriers have openings that can be brought into register with each other so allowing a fastening device to be received through the openings to fasten the locking members to the carriers.

6. The conduit hanger as claimed in claim 1, in which the base defines at least one elongate slot suitable for receiving a pin, shank or the like of a fastening arrangement so that the hanger can be mounted to a support structure in an adjustable manner both with respect to the support structure and one or more further conduit hangers.

7. The conduit hanger as claimed in claim 1, in which the base and the carrier(s) are formed from one flat sheet of material to define a unitary, one-piece structure.

8. A conduit hanging system which comprises
a plurality of conduit hangers, each conduit hanger comprising
a base;
at least one carrier extending from the base, the, or each, carrier defining a retaining formation in which a respective conduit can be received, the base and the carrier(s) being formed from at least one flat sheet of material; and
at least one obstruction member mounted on one of the base and the, or each respective, associated carrier and displaceable between an inoperative position in which the conduit can be removed from the respective carrier and an operative position in which the conduit is retained in the respective carrier with the obstruction member; and
wherein the conduit hangers are mounted on a support structure to support the conduit(s) along its/their length(s).

9. The conduit hanging system as claimed in claim 8, in which a number of the carriers extend from the base and a number of the obstruction members are arranged on the base to correspond with respective carriers, the conduit hangers being mounted to support a number of conduits spaced relative to each other along their lengths.

10. A method of supporting conduits, the method comprising the steps of:
mounting a plurality of conduit hangers on a support structure, each conduit hanger comprising
a base;
at least one carrier extending from the base, the, or each, carrier defining a retaining formation in which a respective conduit can be received, the base and the carrier(s) being formed from at least one flat sheet of material; and
at least one obstruction member mounted on one of the base and the, or each respective, associated carrier and displaceable between an inoperative position in which the conduit can be removed from the respective carrier and an operative position in which the conduit is retained in the respective carrier with the obstruction member; and
securing a conduit to at least two consecutive carriers of the hangers.

11. The method as claimed in claim 10, in which a number of the carriers extend from the base and a number of the obstruction members are arranged on the base to correspond with respective carriers, the method including the step of mounting the conduit hangers to support a number of conduits spaced relative to each other along their lengths.

12. The method as claimed in claim 10, which further comprises the steps of:
fastening an upper end of the base to a support structure; and
fastening a lower end of the base to the support structure subsequent to securing the conduit(s) to the carrier(s).
